(19) United States
(12) Patent Application Publication
(10) Pub. No.: US 2022/0100200 A1
(43) Pub. Date: Mar. 31, 2022

(54) Shared Obstacles in Autonomous Vehicle Systems

(71) Applicant: Autonomous Solutions, Inc., Mendon, UT (US)

(72) Inventors: Taylor Bybee, Mendon, UT (US); Bryant Chandler, Mendon, UT (US); Brad Baillio, Mendon, UT (US); Terence Keegan, Mendon, UT (US); Jeff Ferrin, Mendon, UT (US); Levi Baker, Mendon, UT (US); Jeremy Harris, Mendon, UT (US)

(21) Appl. No.: 17/489,507

(22) Filed: Sep. 29, 2021

Related U.S. Application Data
(60) Provisional application No. 63/085,768, filed on Sep. 30, 2020.

(51) Int. Cl. G05D 1/02; G05D 1/00

(52) U.S. Cl. CPC G05D 1/0238; G05D 1/0274; G05D 1/0044; G05D 1/0088; G05D 1/0287

(57) ABSTRACT

Embodiments of an autonomous vehicle are disclosed. In some embodiments, the autonomous vehicle includes a sensor array that can produce sensor data. The autonomous vehicle further includes a transceiver that can communicate with and receive data from at least a base station. Further, the autonomous vehicle includes a controller communicatively coupled with the sensor array and the transceiver. The controller includes code that receives a navigation plan data via the transceiver and navigates the autonomous vehicle along a navigation path specified in the navigation plan in such a manner as to avoid an interaction with one or more actual obstacles, in and around the navigation path, detected based at least in part on the sensor data.

### BACKGROUND

An autonomous vehicle may autonomously control its operation, for example, based on high level instructions. For instance, an autonomous vehicle may be capable of operating with limited or even no human direction beyond the high-level instructions. As such, an autonomous vehicle may be utilized in wide array of operations having different types of work areas and/or navigation paths. For example, the autonomous vehicle may operate in a work area that may have one or more perceived obstacles in a navigation path of the autonomous vehicle.

### SUMMARY

Systems and methods are disclosed for identifying shared obstacles in autonomous vehicle systems.

In some embodiments, the autonomous vehicle includes a sensor array that can produce sensor data. The autonomous vehicle further includes a transceiver that can communicate with and receive data from at least a base station. Further, the autonomous vehicle includes a controller communicatively coupled with the sensor array and the transceiver. The controller includes code that receives a navigation plan data via the transceiver and navigates the autonomous vehicle along a navigation path specified in the navigation plan in such a manner as to avoid an interaction with one or more actual obstacles, in and around the navigation path, detected based at least in part on the sensor data.

In some embodiments, the sensor array includes at least one sensor selected from the list consisting of lidar, radar, camera, flash lidar and sonar. In some embodiments, the autonomous vehicle includes an operator interface communicatively coupled with the controller. In some embodiments, the controller has code that displays information associated with the one or more perceived obstacles on a display in the operator interface. In some embodiments, the controller has code that receives an operator input in response to the displayed information associated with the one or more perceived obstacles. In some embodiments, the controller has code that modifies the navigation path or a behavior of the autonomous vehicle based on the operator input.

In some embodiments, the controller has code that detects the one or more perceived obstacles based on terrain sensing and ground/no-ground segmentation associated with the navigation path. In some embodiments, the controller has code that modifies the navigation path or a behavior of the autonomous vehicle based on the one or more perceived obstacles detected in and around the navigation path. In some embodiments, the controller has code that transmits via the transceiver to the base station the information associated with the one or more perceived obstacles detected in and around the navigation path.

In some embodiments, the controller has code that modifies the navigation path or a behavior of the autonomous vehicle based on an instruction received from the base station via the transceiver. In some embodiments, the instruction corresponds to ignoring or avoiding the one or more actual obstacles by the autonomous vehicle. In some embodiments, the controller has code that transmits, via the transceiver to the base station, the operator input and the information associated with the one or more perceived obstacles detected in and around the navigation path.

In some embodiments, the controller has code that receives via the transceiver from the base station, a geolocation map indicating location(s) of a first set of obstacles shared between a group of autonomous vehicles. In some embodiments, the first set of obstacles include the one or more perceived obstacles detected in and around the navigation path. In some embodiments, the controller has code that modifies the navigation path or a behavior of the autonomous vehicle based on the first set of obstacles indicated in the geological map. In some embodiments, the location(s) of the first set of obstacles correspond to relative location(s) of the first set of obstacles with respect to the autonomous vehicle.

In some embodiments, the autonomous vehicle further includes an artificial intelligence engine communicatively coupled with the controller. The controller has code that instructs the artificial intelligence engine to determine whether the one or more perceived obstacles detected in and around the navigation path correspond to a true positive or a false positive. In some embodiments, the controller has code that modifies the navigation path or a behavior of the autonomous vehicle based on the determination by the artificial intelligence engine. In some embodiments, the controller includes code that ignores warnings indicating a potential interaction of the autonomous vehicle with the one or more perceived obstacles based on the determination by the artificial intelligence engine. In some embodiments, the artificial intelligence engine includes one or more mathematical models to determine one or more characteristics associated with the one or more perceived obstacles. In some embodiments, the determination of whether the one or more perceived obstacles correspond to a true positive or a false positive is based at least in part on the determined one or more characteristics.

Embodiments of a method of operating an autonomous vehicle are disclosed. In some embodiments, the method includes generating sensor data by a sensor array in an autonomous vehicle. The method further includes receiving a navigation plan data by a transceiver in the autonomous vehicle and navigating the autonomous vehicle along a navigation path specified in the navigation plan data in such a manner so as to avoid an interaction with one or more actual obstacles, in and around the navigation path, detected based at least in part on the sensor data.

In some embodiments, the sensor array comprises at least one sensor selected from the list consisting of lidar, radar, camera, flash lidar and sonar. In some embodiments, the method further includes displaying information associated with the one or more perceived obstacles on a display. In some embodiments, the method further includes receiving an operator input in response to the displaying of information associated with the one or more perceived obstacles. In some embodiments, the method further includes modifying the navigation path or a behavior of the autonomous vehicle based on the operator input. In some embodiments, the method further includes detecting the one or more perceived obstacles based on terrain sensing and ground/no-ground segmentation associated with the navigation path.

In some embodiments, the method further includes modifying the navigation path or a behavior of the autonomous vehicle based on the one or more actual obstacles detected in and around the navigation path. In some embodiments, the method further includes transmitting by the transceiver to a base station the information associated with the one or more perceived obstacles detected in and around the navigation path. In some embodiments, the method further includes modifying the navigation path or a behavior of the autonomous vehicle based on an instruction received from the base station via the transceiver. In some embodiments, the instruction corresponds to one of ignoring or avoiding the one or more actual obstacles. In some embodiments, the method further includes transmitting, via the transceiver to a base station, the operator input and the information associated with the one or more obstacles detected in and around the navigation path.

In some embodiments, the method further includes receiving via the transceiver from a base station, a geolocation map indicating location(s) of a first set of obstacles shared between a group of autonomous vehicles. In some embodiments, the first set of obstacles include the one or more obstacles detected in and around the navigation path. In some embodiments, the method further includes modifying the navigation path or a behavior of the autonomous vehicle (and/or other autonomous vehicles) based on the first set of obstacles indicated in the geological map. In some embodiments, the location(s) of the first set of obstacles correspond to relative location(s) of the first set of obstacles with respect to the autonomous vehicle.

In some embodiments, the method includes instructing an artificial intelligence engine to determine whether the one or more perceived obstacles detected along the navigation path correspond to a true positive or a false positive. In some embodiments, the method further includes modifying the navigation path or a behavior of the autonomous vehicle based on the determination by the artificial intelligence engine. In some embodiments, the method further includes ignoring warnings indicating a potential interaction of the autonomous vehicle with the one or more perceived obstacles based on the determination by the artificial intelligence engine. In some embodiments, the method further includes determining one or more characteristics associated with the one or more perceived obstacles by the artificial intelligence engine. The determination of whether the one or more perceived obstacles correspond to a true positive or a false positive (e.g., one or more actual obstacles) is based at least in part on the determined one or more characteristics.

The various embodiments described in the summary and this document are provided not to limit or define the disclosure or the scope of the claims.

### BRIEF DESCRIPTION OF THE FIGURES

FIG. 1 illustrates a block diagram of an example autonomous vehicle communication system of the present disclosure.

FIG. 2 is a block diagram of a group of autonomous vehicles 200 in communication with each other via a communication network 205.

FIG. 3 is a block diagram of a publish-subscribe architecture that can be used within the group of autonomous vehicles according to some embodiments.

FIG. 4 illustrates a scenario of sharing information associated with obstacles amongst a group of autonomous vehicles according to some embodiments described in this document.

FIG. 5 illustrates a flowchart of a process for operating an autonomous vehicle according to some embodiments.

FIG. 6 illustrates a flowchart of a process for determining false positives in obstacle detection according to some embodiments described in this document.

FIG. 7 illustrates another flowchart of a process for determining false positives in obstacle detection according to some embodiments described in this document.

FIG. 8 is a block diagram of a computational system that can be used to with or to perform some embodiments described in this document.

### DETAILED DESCRIPTION

Systems and methods are disclosed for identifying shared obstacles in autonomous vehicle systems. Most autonomous control system include an obstacle detection and/or obstacle avoidance subsystem. Such obstacle detection may not always be accurate and may lead to false positives that may impact current and/or future operation of the autonomous vehicle. For example, these systems may modify the navigation path or behavior of the autonomous vehicle when an obstacle is detected along the navigation path. Such auto-correction or modification may not always be desirable especially in cases where the trigger is a “false positive” or an incorrect or an “unreal” detection of an obstacle. Embodiments disclosed in this document allow an Artificial Intelligence (AI) engine that can receive sensor data from a plurality of sensors to generate a list of potential obstacles in the vicinity of the planned navigation path. The disclosed embodiments also allow a user or an operator to be involved with the decision making to, for example, change the navigation path or modify the behavior of the autonomous vehicle.

In some embodiments, an artificial intelligence engine is disclosed that is dedicated to detecting and reporting the one or more perceived obstacles in the navigation path of the autonomous vehicle. In some embodiments, the detection algorithms are based on terrain sensing and ground/non-ground segmentation associated with the navigation path. In some embodiments, the artificial intelligence engine can receive sensor data from a sensor array including one or more sensors, such as, but not limited to, lidar, radar, depth cameras and/or flash lidars and generate a list of potential obstacles (e.g. the one or more perceived obstacles) in and around the planned navigation path. In some embodiments, the artificial intelligence engine can determine whether the one or more detected obstacles correspond to a “true positive” or a “false positive”.

In some embodiments, the list of potential obstacles may be presented to a user or an operator for an evaluation. The user or the operator may make a judgement call on whether the one or more perceived obstacles are legitimate (true positive) or not legitimate (false positive). In some embodiments, such a determination or judgement may be made based at least on partial input/recommendation from the artificial intelligence engine. If a given obstacle is determined to be real or legitimate, a corresponding obstacle notification is added to an autonomous navigation map (or a geolocation map) via the operator interface or the user interface (UI). All future path planning for the autonomous vehicle (and/or other autonomous vehicles) may avoid the obstacle indicated by the autonomous navigation map. If, in the future, the user or the operator wants to remove the obstacle from the autonomous navigation map (or the geolocation map), the user may do so through the operator interface. If the given obstacle is determined to be unreal or a false positive, the user can remove/reject the obstacle notification from the autonomous navigation map (or a geolocation map) and direct the autonomous vehicle to continue on its original navigation path via the operator interface.

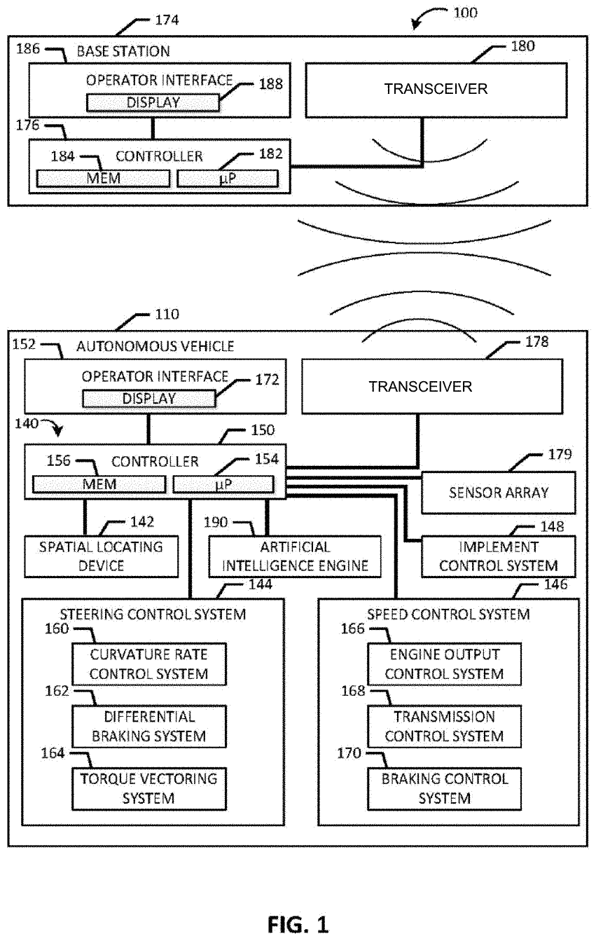

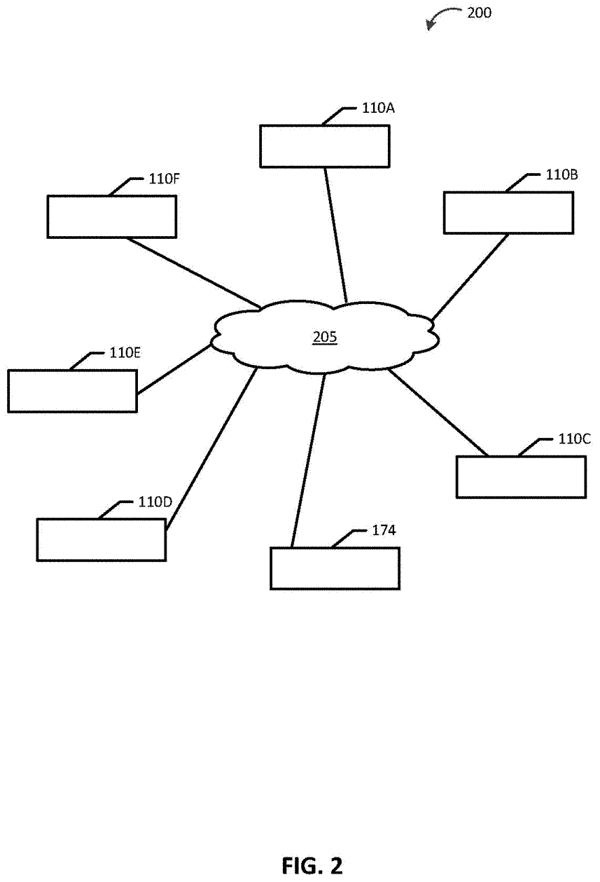

FIG. 1 is a block diagram of an individual autonomous vehicle 110 in communication with a base station 174 according to some embodiments. FIG. 2 is a block diagram of a group of autonomous vehicles 200 in communication with each other via a communication network 205.

In some embodiments, vehicles in a group of autonomous vehicles may share various kind of sensor data such as, for example, wheel slippage data, speed, radar data, lidar data, images, or sonar data, etc. In some embodiments, vehicles in a group of vehicles may share various kind of sensor derived data such as, for example, one or more perceived obstacles, one or more actual obstacles, surface properties, surface disturbances, terrain, paths, path characteristics, environmental characteristics, map data, mathematical models, etc.

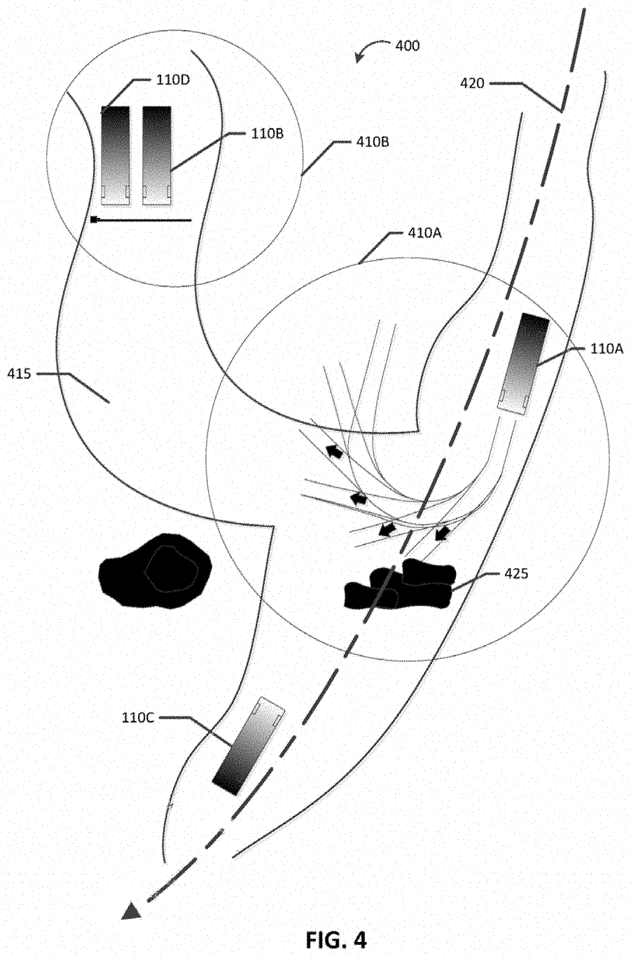

In some embodiments, vehicles in a group of autonomous vehicles may include autonomous ground vehicles in a worksite (e.g., as shown in FIG. 4), autonomous ground vehicles operating at a mine site, autonomous ground vehicles on a farm or ranch, autonomous ground vehicles in a truck yard or shipping yard, autonomous security vehicles, autonomous warehouse vehicles, industrial autonomous vehicles, etc.

In some embodiments, performance of vehicles in a group of autonomous vehicles can be improved by sharing information (e.g., senor data or sensor derived data) pertinent to vehicle control among the group of vehicles. For example, an autonomous vehicle traversing an area can assess information about the area and pass this information back to other autonomous vehicles that have not yet traversed this area. This information may allow for an increased control horizon for the group of autonomous vehicles and/or may allow for some vehicles to operate with fewer sensors. In some embodiments, the information may pertain to one or more perceived obstacles detected by an autonomous vehicle.

In some embodiments, information may be shared using a publish-subscribe architecture among autonomous vehicles. In some embodiments, information requests may be broadcast periodically from one vehicle to the group of autonomous vehicles, and any of the group of vehicles may respond to those requests. In some embodiments, responses may be broadcast to the group of autonomous vehicles so that all the vehicles in the group of autonomous vehicles may use the information. In some embodiments, limitations may be placed on which vehicles may request information or respond with information. These limitations may include, for example, geographical limitations, hierarchal limitations, or priority-based limitations, etc.

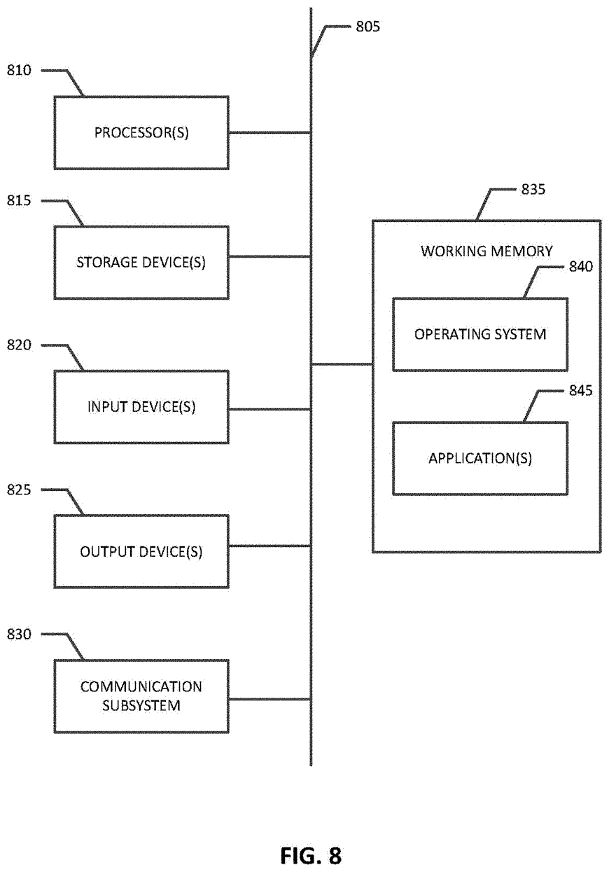

FIG. 1 is a block diagram of a communication and control system 100 that may be utilized in conjunction with the systems and methods of the present disclosure, in at least some embodiments. The communication and control system 100 may include a vehicle control system 140 which may be mounted on an autonomous vehicle 110. The autonomous vehicle 110, for example, may include any type of autonomous vehicle. In some embodiments, the communication and control system 100 may include any or all components of computational system 800 shown in FIG. 8.

The autonomous vehicle 110, for example, may also include a spatial locating device 142, which may be mounted to the autonomous vehicle 110 and configured to determine a position of the autonomous vehicle 110 as well as a heading and a speed of the autonomous vehicle 110. The spatial locating device 142, for example, may include any suitable system configured to determine the position and/or other characteristics of the autonomous vehicle 110, such as a global positioning system (GPS), a global navigation satellite system (GNSS), or the like. In some embodiments, the spatial locating device 142 may determine the position and/or other characteristics of the autonomous vehicle 110 relative to a fixed point within a field (e.g., via a fixed radio transceiver). In some embodiments, the spatial locating device 142 may determine the position of the autonomous vehicle 110 relative to a fixed global coordinate system using GPS, GNSS, a fixed local coordinate system, or any combination thereof. In some embodiments, the spatial locating device 142 may include any or all components of computational system 800 shown in FIG. 8.

In some embodiments, the autonomous vehicle 110 may include a steering control system 144 that may control a direction of movement of the autonomous vehicle 110. In some embodiments, the steering control system 144 may include any or all components of computational system 800 shown in FIG. 8.

In some embodiments, the autonomous vehicle 110 may include a speed control system 146 that controls a speed of the autonomous vehicle 110. In some embodiments, the autonomous vehicle 110 may include an implement control system 148 that may control operation of an implement towed by the autonomous vehicle 110 or integrated within the autonomous vehicle 110. In some embodiments, the implement control system 148 may, for example, include any type of implement such as, for example, a bucket, a shovel, a blade, a dump bed, a plow, an auger, a trencher, a scraper, a broom, a hammer, a grapple, forks, boom, spears, a cutter, a tiller, a rake, etc. In some embodiments, the speed control system 146 may include any or all components of computational system 800 shown in FIG. 8.

In some embodiments, the autonomous vehicle 110 may include an artificial intelligence engine 190 that can identify one or more sensed obstacles in and around the navigation path of the autonomous vehicle based on sensor data. In some embodiments, the artificial intelligence engine 190 may determine whether the one or more detected obstacles sensed around the navigation path correspond to a “true positive” or a “false positive” (e.g., an actual obstacle). In some embodiments, the artificial intelligence engine 190 may include one or more mathematical models to determine one or more characteristics associated with the one or more detected obstacles. In such embodiments, the determination of whether the one or more obstacles correspond to a “true positive” or a “false positive” is based on the one or more characteristics. The one or more characteristics associated with the one or more detected obstacles, for example, may include surface texture, color, surface depth, material composition, dimension, location with respect to the autonomous vehicle, edge contours, profile, optical characteristics, etc.

In some embodiments, the artificial intelligence engine 190 may include one or more pattern recognition algorithms, obstacles recognition algorithms, machine (ML) learning algorithms, etc. for “true” detection of one or more obstacles. In some embodiments, the artificial intelligence engine 190 may access one or more local or remote databases such as but not limited to obstacle database, object database, pattern database, surface model database, material composition database, etc. In some embodiments, the artificial intelligence engine 190 may be implemented as a system on chip (SoC) or integrated with the microprocessor 154 itself. In some embodiments, the artificial intelligence engine 190 may be implemented in the base station 174 as a separate component or system on chip (SoC) or may be integrated with the microprocessor 182. In some embodiments, the artificial intelligence engine 190 may be implemented in the autonomous vehicle 110 and the base station 174. In some embodiments, the artificial intelligence engine 190 may autonomously detect one or more obstacles with minimal or no input from an operator of the autonomous vehicle or otherwise. The artificial intelligence engine 190 may reject or ignore an obstacle notification if it determines that the detection was a “false positive”. In some embodiments, the artificial intelligence engine 190 may include any or all components of computational system 800 shown in FIG. 8.

In some embodiments, the control system 140 may include a controller 150 communicatively coupled to the spatial locating device 142, the steering control system 144, the speed control system 146, the implement control system 148, and the artificial intelligence engine 190. In some embodiments, the control system 140 and/or the controller 150 may include any or all the components of computational system 800. In some embodiments, the control system 140 may be integrated into a single control system. In other embodiments, the control system 140 may include a plurality of distinct control systems. In some embodiments, the control system 140 may be integrated with the artificial intelligence engine 190.

In some embodiments, the controller 150 may receive signals relative to many parameters of interest including, but not limited to: vehicle position, vehicle speed, vehicle heading, desired path location, off-path normal error, desired off-path normal error, vehicle state vector information, curvature state vector information, turning radius limits, steering angle, steering angle limits, steering rate limits, curvature, curvature rate, rate of curvature limits, roll, pitch, rotational rates, acceleration, and the like, or any combination thereof.

In some embodiments, the controller 150 may be an electronic controller with electrical circuitry configured to process data from the spatial locating device 142, among other components of the autonomous vehicle 110. The controller 150 may include a processor, such as the processor 154, and a memory device 156. The controller 150 may also include one or more storage devices and/or other suitable components (not shown). The controller 150 may also include the artificial intelligence engine 190. The processor 154 may be used to execute software, such as software for calculating drivable path plans. Moreover, the processor 154 may include multiple microprocessors, one or more “general-purpose” microprocessors, one or more special-purpose microprocessors, and/or one or more application specific integrated circuits (ASICS), or any combination thereof. For example, the processor 154 may include one or more reduced instruction set (RISC) processors or complex instruction set computer (CISC). In some embodiments, the controller 150 may include any or all the components show in FIG. 8.

In some embodiments, the memory device 156 may include a volatile memory, such as random access memory (RAM), and/or a nonvolatile memory, such as ROM. The memory device 156 may store a variety of information and may be used for various purposes. For example, the memory device 156 may store processor-executable instructions (e.g., firmware or software) for the processor 154 to execute, such as instructions for calculating drivable navigation path plan, and/or controlling the autonomous vehicle 110. The memory device 156 may include flash memory, one or more hard drives, or any other suitable optical, magnetic, or solid-state storage medium, or a combination thereof. The memory device 156 may store data such as field maps, geolocation maps, autonomous maps of desired navigation paths, vehicle characteristics, software or firmware instructions and/or any other suitable data.

In some embodiments, the steering control system 144 may include a curvature rate control system 160, a differential braking system 162, and a torque vectoring system 164 that may be used to steer the autonomous vehicle 110. In at least one embodiment, the curvature rate control system 160 may control a direction of an autonomous vehicle 110 by controlling a steering system of the autonomous vehicle 110 with a curvature rate, such as an Ackerman style autonomous vehicle 110. In other embodiments, the curvature rate control system 160 may automatically rotate one or more wheels or tracks of the autonomous vehicle 110 via hydraulic actuators to steer the autonomous vehicle 110. By way of example, the curvature rate control system 160 may rotate front wheels/tracks, rear wheels/tracks, and/or intermediate wheels/tracks of the autonomous vehicle 110, either individually or in groups. The differential braking system 162 may independently vary the braking force on each lateral side of the autonomous vehicle 110 to direct the autonomous vehicle 110. Similarly, the torque vectoring system 164 may differentially apply torque from the engine to the wheels and/or tracks on each lateral side of the autonomous vehicle 110. While the illustrated steering control system 144 includes the curvature rate control system 160, the differential braking system 162, and the torque vectoring system 164, it should be appreciated that alternative embodiments may include one or more of these systems, in any suitable combination. Further embodiments may include a steering control system 144 having other and/or additional systems to facilitate turning the autonomous vehicle 110 such as an articulated steering system, a differential drive system, and the like.

In some embodiments, the speed control system 146 may include an engine output control system 166, a transmission control system 168, and a braking control system 170. The engine output control system 166 may vary the output of the engine to control the speed of the autonomous vehicle 110. For example, the engine output control system 166 may vary a throttle setting of the engine, a fuel/air mixture of the engine, a timing of the engine, and/or other suitable engine parameters to control engine output. In addition, the transmission control system 168 may adjust gear selection within a transmission to control the speed of the autonomous vehicle 110. Furthermore, the braking control system 170 may adjust braking force to control the speed of the autonomous vehicle 110. While the illustrated speed control system 146 includes the engine output control system 166, the transmission control system 168, and the braking control system 170, it should be appreciated that alternative embodiments may include one or two of these systems, in any suitable combination. Further embodiments may include a speed control system 146 having other and/or additional systems to facilitate adjusting the speed of the autonomous vehicle 110.

In some embodiments, the implement control system 148 may control various parameters of the implement towed by and/or integrated within the autonomous vehicle 110. For example, the implement control system 148 may instruct an implement controller via a communication link, such as a CAN bus or ISOBUS.

The implement control system 148, as another example, may instruct the implement controller to adjust a bucket height, a bucket angle, a bucket position, etc.

In some embodiments, the vehicle control system 100 may include a sensor array 179. In some embodiments, the sensor array 179 may facilitate determination of condition(s) of the autonomous vehicle 110 and/or the work area. For example, the sensor array 179 may include multiple sensors (e.g., infrared sensors, ultrasonic sensors, magnetic sensors, radar sensors, Lidar sensors, terahertz sensors, sonar sensors, etc.) that monitor a rotation rate of a respective wheel or track and/or a ground speed of the autonomous vehicle 110. The sensors may also monitor operating levels (e.g., temperature, fuel level, etc.) of the autonomous vehicle 110. Furthermore, the sensors may monitor conditions in and around the work area, such as temperature, weather, wind speed, humidity, and other conditions. In some embodiments, the sensors may detect one or more obstacles such as, for example, physical objects such as the parking stall, the material stall, accessories, other vehicles, or other object(s) that may be in the area surrounding the autonomous vehicle 110 or in and around the navigation path of the autonomous vehicle. The detected physical objects or obstacles may be mapped in software creating a digital representation of the sensed area such as, for example, as GPS data or GPS points forming one or more polygons. This digital representation may be shared among a plurality of autonomous vehicles.

In some embodiments, the digital representation of the sensed area may be an autonomous map or geolocation map. In some embodiments, the geolocation map can be locally stored in the autonomous vehicle 110 and updated based on the one or more detected obstacles. In some embodiments, the geolocation map can be remotely stored in the base station 174 and updated based on the one or more detected obstacles by a group of autonomous vehicles 200. In some embodiments, the geolocation map may include a first set of obstacles that are shared amongst the group of autonomous vehicles operating in a worksite. The geolocation map may be indicative of locations of the first set of obstacles. In some embodiments, the first set of obstacles correspond to all the obstacles that have been detected by the group of autonomous vehicles 200. In some embodiments, the first set of obstacles are shared amongst all the vehicles amongst the group of autonomous vehicles 200. In some embodiments, all the autonomous vehicles in the group of autonomous vehicles constantly or periodically update the locally stored geolocation map and also the remotely stored geolocation map to reflect “true positives” or real detection of one or more obstacles in real time. In some embodiments, all the autonomous vehicles in the group of autonomous vehicles constantly or periodically update the locally stored geolocation map and also the remotely stored geolocation map to reflect “false positives” or unreal detection of one or more obstacles in real time. Further, the sensor array 179 may be utilized by one or more obstacle avoidance systems.

In some embodiments, the controller 150 may include any or all the components of the computational system 800.

The operator interface 152 may be communicatively coupled to the controller 150 and configured to present data from the autonomous vehicle 110 via a display 172. Display data may include: data associated with operation of the autonomous vehicle 110, data associated with operation of an implement, a position of the autonomous vehicle 110, a speed of the autonomous vehicle 110, a desired path, a drivable navigation path plan, a target position, a current position, information associated with the one or more obstacles, etc. The operator interface 152 may enable an operator to control certain functions of the autonomous vehicle 110 such as starting and stopping the autonomous vehicle 110, inputting a desired navigation path, overriding a warning signal or obstacle notification, etc. In some embodiments, the operator interface 152 may enable the operator to input parameters that cause the controller 150 to adjust the drivable navigation path plan. For example, the operator may provide an input requesting that the desired path be acquired as quickly as possible, that an off-path normal error be minimized, that a speed of the autonomous vehicle 110 remain within certain limits, that a lateral acceleration experienced by the autonomous vehicle 110 remain within certain limits, etc. In addition, the operator interface 152 (e.g., via the display 172, or via an audio system (not shown), etc.) may alert an operator in the autonomous vehicle 110 or located at or near the communication and control system 100 if the desired path cannot be achieved, for example.

In some embodiments, the control system 140 may include a base station 174 having a base station controller 176 located remotely from the autonomous vehicle 110. For example, in some embodiments, control functions of the control system 140 may be distributed between the controller 150 of the autonomous vehicle control system 140 and the base station controller 176. In some embodiments, the base station controller 176 may perform a substantial portion of the control functions of the control system 140. For example, in some embodiments, a first transceiver 178 positioned on the autonomous vehicle 110 may output signals indicative of vehicle characteristics (e.g., position, speed, heading, curvature rate, curvature rate limits, maximum turning rate, minimum turning radius, steering angle, roll, pitch, rotational rates, acceleration, etc.) to a second transceiver 180 at the base station 174 or to other first transceivers on other autonomous vehicles via a wireless network. In some embodiments, the first transceiver 178 may output signals indicative of one or more detected obstacles detected in and around the navigation path of the autonomous vehicle 110. In some embodiments, the first transceiver 178 may output signals indicative of one or more detected obstacles detected in and around the navigation path of the autonomous vehicle 110 along with operator input received in response to displaying the information of one or more obstacles on the operator interface 186.

In some embodiments, an operator input may override a false detection of obstacles. In some embodiments, the operator may do so by interacting with operator interface 186 and/or operator interface 152. In some embodiments, the operator input may override a determination of a “true positive” or a “false positive” by the artificial intelligence engine 190. In some embodiments, the operator interface 186 may provide the operator with options to update the geolocation map based on a determination of “true positive” or “false positive”. For example, the operator interface 186 may provide options to the operator to add or remove (information about) the one or more obstacles (from the geolocation map) based on the operator's judgement. In some embodiments, the operator interface 186 may provide options (to the operator) to include the one or more obstacles in a future navigation path plan for the autonomous vehicle 110 or for a group of autonomous vehicles.

In some embodiments, the base station controller 176 may calculate drivable path plans (navigation plan) and/or output control signals to control the curvature rate control system 144, the speed control system 146, and/or the implement control system 148 to direct the autonomous vehicle 110 toward the desired path, for example. In some embodiments, the base station controller 176 may output instructions to the autonomous vehicle 110. Such instructions, for example, may correspond to avoiding or ignoring the one or more detected obstacles. In some embodiments, such instructions may correspond to commands or input from a remote operator of the base station 174 in response to an obstacle notification from the autonomous vehicle 110.

The base station controller 176 may include a processor 182 and memory device 184 having similar features and/or capabilities as the processor 154 and the memory device 156 discussed previously. The base station controller 176 may include any or all the components of computational system 800. In some embodiments, the base station 174 may include an operator interface 186 having a display 188, which may have similar features and/or capabilities as the operator interface 152 and the display 172 discussed previously.

In some embodiments, the operator interface 186 may receive obstacle data from the autonomous vehicle 110 that may include raw sensor data. The operator interface 186 may display obstacle data to a user via the display 188. The user may provide an indication to the operator interface 186 via a user interface that the obstacle is an actual obstacle (e.g., “true positive”) or not an obstacle (e.g., “false positive”). The base station controller 176 may label the obstacle as an actual obstacle or a false obstacle and/or may communicate to the autonomous vehicle 110 (and other autonomous vehicles) that the obstacle is an actual obstacle or a false obstacle. This may be done, for example, via one or more paths.

FIG. 2 is a block diagram of a group of autonomous vehicles 110 in communication with each other via a communication network 205. In this example, the autonomous vehicles 110 may also be in communication with the base station 174 via the communication network 205. In this example, six autonomous vehicles are shown: autonomous vehicle 110A, autonomous vehicle 110B, autonomous vehicle 110C, autonomous vehicle 110D, autonomous vehicle 110E, autonomous vehicle 110F (individually or collectively referred to as autonomous vehicle 110).

In some embodiments, the base station 174 may be located at a fixed location, in the cloud, or on one or more of the autonomous vehicles 110.

In some embodiments, the communication network 205 may include any type of wireless communication network such as, for example, a 5G network, a 4G network, an LTE network, a Wi-Fi network, a cellular network, etc. In some embodiments, the communication network 205 may be established or maintained on one or more of the autonomous vehicles 110.

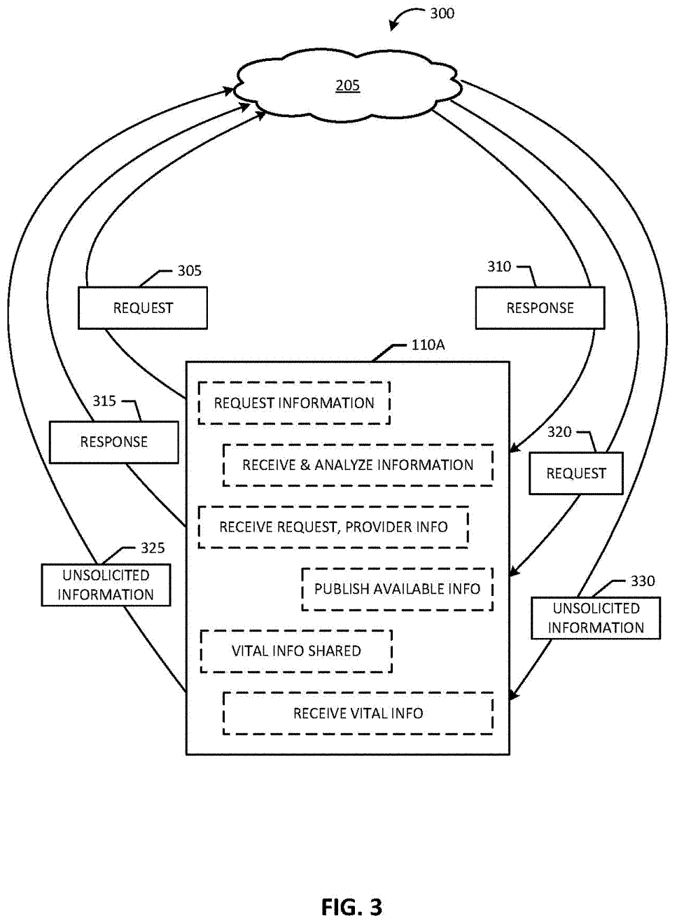

FIG. 3 is a block diagram of a publish-subscribe architecture 300 that can be used within a group of autonomous vehicles (e.g., the group of autonomous vehicles 200) according to some embodiments. In some embodiments, due to network bandwidth and latency constraints, it may be unreasonable to send raw sensor data from one autonomous vehicle to another within the group of autonomous vehicles 200. In some embodiments, in the publish-subscribe architecture 300 semantic information may be shared among autonomous vehicles in a group of autonomous vehicles. The semantic information, for example, may include a mathematical model based on sensor data. As another example, the semantic information may include compressed data. As another example, the semantic information may include filtered sensor data. As another example, the semantic information may not include raw sensor data. As another example, the semantic information may include sensor data fitted to a mathematical model.

In some embodiments, the semantic information may include data that has been compressed by fitting sensor data to a mathematical model. The model, for example, may include a model representing path disturbances, a terrain map, an occupancy grid, an obstacle list, an occlusion map, a slope map, GPS points, an array of GPS points representing one or more polygons, etc. In some embodiments, each autonomous vehicle 110 of the group of autonomous vehicles 200 may maintain a mathematical model and may share this mathematical model with other autonomous vehicles 110 of the group of autonomous vehicles 200.

For example, the autonomous vehicle 110A of the group of autonomous vehicles 200 can broadcast an information request 305 to the other autonomous vehicles (e.g., 110B, 110C, 110D, 110E, 110F, etc.) of the group of autonomous vehicles 200 through the communication network 205. Each or a subset of the group of autonomous vehicles may receive this request, determine if any of the requested information is available, then broadcasts a response 310. In some embodiments, the autonomous vehicle 110A may receive a response from more than one autonomous vehicle of the group of autonomous vehicles. The requesting vehicle 110A may receive all the semantic responses, analyze the data, and/or combine this received information with its own model. In some embodiments, this may result, for example, in a more complete model.

As another example, the autonomous vehicle 110A of the group of autonomous vehicles 200 may receive an information request 320 from one or more of the other autonomous vehicles (e.g., 110B, 110C, 110D, 110E, 110F, etc.) of the group of autonomous vehicles 200 through the communication network 205. The autonomous vehicle 110A may receive this request, determine if any of the requested information is available, and broadcasts a response 315.

As another example, the autonomous vehicle 110A of the group of autonomous vehicles 200 may determine that there may be some mission-critical information such as, for example, the existence of one or more detected obstacles in and around the navigation path, a steep slope, tire slippage, occlusions, GPS points, an array of GPS points representing one or more polygons, etc. The autonomous vehicle 110A may broadcast this mission-critical information as unsolicited information 325 to each autonomous vehicle of the group of autonomous vehicles 200.

The autonomous vehicle 110A may also receive mission-critical information as unsolicited information 330 from other autonomous vehicles of the group of autonomous vehicles 200.

In some embodiments, each autonomous vehicle may have a responsibility to broadcast an information request 305 or 320 to other autonomous vehicles. These broadcasts may occur periodically or may be based on a trigger such as, for example, a time based trigger, a location based trigger, an operator based trigger, a system trigger, an external trigger, event trigger, a sensed obstacle trigger, a trigger based on sensed data, etc. For example, location-based data (e.g., and may be static over time) may be a location based trigger that may include a broadcast when an autonomous vehicle enters a new area based on geolocation data. As another example, for data that changes over time such as, for example, coordinates of moving obstacles or vehicles, etc., may include a trigger that is repeated periodically such as, for example, every 5, 10, 15, 30, etc. minutes.

Ad hoc triggers may also occur such as, for example, when an autonomous vehicle detects an obstacle in close proximity to any of the autonomous vehicles in the group of autonomous vehicles, the autonomous vehicle may warn the other autonomous vehicles without waiting for the request-response sequence to occur (e.g., unsolicited information 325). For example, an autonomous vehicle may broadcast this information using the unsolicited message communication sequence. An ad hoc trigger, for example, may occur when time-sensitive or mission-critical information needing to be immediately shared.

When an autonomous vehicle receives information, either in the request-response or unsolicited sequence, it may merge this information into its own model. Information-merging, for example, may allow for each autonomous vehicle to maintain control of its model while still using the information from nearby autonomous vehicles. The algorithm(s) used to merge the incoming information into existing information may be dependent on what model is being shared and may use statistical or tuning information to merge the information.

For example, a Kalman filter or a Bayesian prediction algorithm may be used to merge the received information with its own model.

In some embodiments, data received from other vehicles may be weighted prior to or during a merge. For example, data from an autonomous vehicle known to include additional sensors, better sensors, or alternative sensors may be more highly weighted. As another example, data from a lead autonomous vehicle in a convoy of vehicles may be more heavily weighted than other autonomous vehicles in the convoy.

In some embodiments, to limit the amount of request and response network traffic, some restrictions can be placed on which vehicles can send or receive certain types of information. For example, in a convoy where the leader autonomous vehicle may not need any information from a follower autonomous vehicle. A leader autonomous vehicle may be restricted from sending any information requests 305. As another example, an autonomous vehicle (e.g., a follower autonomous vehicle) may not have a full-sensor suite, and, thus, may not respond to some requests. This concept allows for the information shared to remain independent or close-to-independent.

In some embodiments, the publish-subscribe architecture may use a data distribution service algorithm.

FIG. 4 illustrates an example scenario of sharing information associated with obstacles amongst a group of autonomous vehicles in a worksite 400 according to some embodiments. In some embodiments, the worksite 400 includes one or more zones such as, a work zone 410A, a park zone 410B, and one or more paths 415. In some embodiments, the boundaries of the park zone 410B, the paths 415, or the work zone 410A may be defined within a mapping software such as, for example, at a base station.

In some embodiments, the park zone 410B may be located a distance from, be contiguous with, overlap with, or be part of work zone 410A. The park zone 410B may include one or more autonomous vehicles (e.g. 110B) parked in a shutdown state. The park zone 410B may include autonomous vehicles (e.g. 110D) that are not in use, parked, broken, under inspection, stored, under maintenance, etc. In some embodiments, a worksite 400 may include a plurality of park zones 410B. The park zone 410B, for example, may include buildings, maintenance crews, etc.

In some embodiments, the work zone 410A is an area were the autonomous vehicle 110A works such as, for example, by interacting with other vehicles and/or load zones. In some embodiments, the work zone 410A may include various other autonomous vehicles such, for example, autonomous vehicles (e.g. 110C). The work zone 410A, for example, may include one or more load zones. The load zone, for example, may include any type of potential load that that may be loaded by the autonomous loader. The load zone, for example, may include material in a pile, mound, ground, subsurface, hillside, etc. as well as material dumped from a conveyor, loader, dump truck, belly dump, etc. As another example, the material may include rock, sand, rubble, ore, tailings, chemicals, fertilizers, waste, organic materials, foodstuffs, manufacturing wastes, slag byproducts, food products, rock, debris, salt corn, etc.

In some embodiments, the path 415 may include a plurality of paths. The path 415, for example, may be a road between work zone 410A and park zone 410B or between two different work zones. In some embodiments, the path 415 may include one or more slopes. One of the paths may correspond to a navigation path 420 for the autonomous vehicle 110A in the work zone 410A. An obstacle 425 may be found on the path 415 that may include for example, rubble, rock, mud, drop-offs, broken vehicles, humans, debris, etc. In some embodiments, the obstacles 425 may correspond to any material or object that may potentially obstruct the navigation of an autonomous vehicle along a navigation path. In some embodiments, the obstacles 425 may be in a stationary state or in a moving or non-stationary state.

In some embodiments, a path may be one way or bidirectional. For example, path 415 may be a one way path from the park zone 410B to the work zone 410A or the path 415 may be a one way path from the work zone 410A to the park zone 410B.

In this work zone 410A, the autonomous vehicles may follow the various embodiments described in this document. For example, a first autonomous vehicle 110A may drive through navigation path 420 and encounter a slope. In doing so, the autonomous vehicle 110A may create a mathematical model of the terrain from data collected by the various sensors such as, for example, a heightmap. Another autonomous vehicle 110C may approach the slope, create a second heightmap from sensor data, and send a request for terrain data at or near that location. The request may indicate the geolocation and/or that terrain data is required. The autonomous vehicle 110A may respond by sending the heightmap to the second autonomous vehicle 110C.

As another example, the autonomous vehicle 110A may encounter the obstacle 425 in and around the navigation path 420 in the work zone 410A. The autonomous vehicle 110A may sense the obstacle 425 and create a mathematical model representing the obstacle 425 within the space. Because these obstacles may impact an autonomous vehicle's ability to follow a path, the first autonomous vehicle 110A may send an unsolicited message to the other autonomous vehicles. This unsolicited message may include data specifying the geolocation, the type of vital information (e.g., obstacle, slick area, etc.), and/or the mathematical model representing the space near the obstacle to each of the autonomous vehicles 110 and/or the base station 174. In some embodiments, this unsolicited message may include information associated with the one or more obstacles, an operator input ignoring an obstacle, a false or a true detection, one or more characteristics associated with the obstacles.

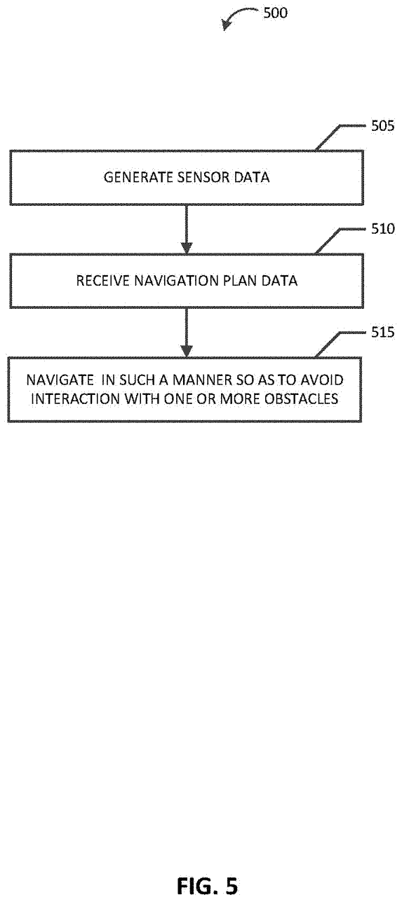

FIG. 5 illustrates a flowchart of a process 500 for operating an autonomous vehicle according to some embodiments. Process 500 may include additional blocks. The blocks shown in process 500 may occur in any order. One or more blocks shown in process 500 may be replaced with another block or removed.

At block 505, sensor data may be generated by sensor array (e.g. 179) mounted on the autonomous vehicle 110A. The sensor array 179 may include any kind of sensor such as, for example, infrared sensors, ultrasonic sensors, magnetic sensors, radar sensors, lidar sensors, terahertz sensors, sonar sensors. In some embodiments, the sensor data may indicate the presence of one or more obstacles in the vicinity of the autonomous vehicle 110A.

At block 510, navigation plan data is received by a transceiver 178 in the autonomous vehicle 110A from the base station 174. In some embodiments, the navigation plan data includes a navigation path (e.g. 420). In some embodiments, the navigation plan data may be locally stored in the autonomous vehicle or fed as an operator input by a user or an operator of the autonomous vehicle 110A. In some embodiments, the sensor data may indicate; the presence of one or more obstacles 425 in and around the navigation path 420 of the autonomous vehicle 110A. In some embodiments, the one or more obstacles 425 are detected based at least in part on the sensor data. In some embodiments, the one or more obstacles are detected by the artificial intelligence engine 190 based at least in part on the sensor data. In some embodiments, the one or more obstacles may be detected based on an operator input received in response to an obstacle notification to the operator. In some embodiments, a list of potential one or more obstacles may be presented to the operator. In some embodiments, the detection of one or more obstacles may be based on a recommendation from the artificial intelligence engine 190 to the operator. In some embodiments, the operator can override the detection of the one or more obstacles by the artificial intelligence engine 190.

At block 515, autonomous vehicle 110A may be navigated in such a manner to avoid an interaction with one or more obstacles 425 detected in and around the navigation path 420. In some embodiments, the interaction may correspond to a state of collision, a state of being proximate within a pre-determined distance of the obstacle, any contact with the obstacle, a specified view of the obstacle, sensing of a property of the obstacle beyond a predetermined threshold, for example. In some embodiments, a request may be broadcast from the autonomous vehicle 110A to other autonomous vehicles (e.g. 110C). The request, for example, may include coordinate data specifying the coordinates where for which data (e.g. information associated with one or more obstacles) is requested. The request may include other information such as, for example, geolocation data, time data, etc.

In some embodiments, the autonomous vehicle 110A, for example, may include a geolocation map. The geolocation map, for example, may associate sensor data with a physical location such as, for example, in an array grid. Any type of mathematical model may be used for implementing the geolocation map and for detecting and marking one or more obstacles on the geolocation map. The mathematical model may model terrain, slippage, obstacles, etc. In some embodiments, terrain sensing and ground/no-ground segmentation associated with the navigation path may be used for detection of one or more obstacles. In some embodiments, the process 500 includes modifying the navigation path or a behavior of the autonomous vehicle 110A based on the one or more obstacles 425 detected in and around the navigation path. Such modification may be made to avoid an interaction of the autonomous vehicle with the one or more obstacle.

In some embodiments, the information associated with the one or more obstacles may be presented to the user (or operator) at the base station 174. In some embodiments, the information associated with the one or more obstacles may be presented or displayed on the operator interface 186 (e.g. on the display 188) at the base station 174. In some embodiments, a list of potential one or more obstacles may be presented to the user for review and/or verification. Based on the operator's judgement, the operator may provide one or more inputs to indicate a decision with respect to the potential one or more obstacles. In some embodiments, the operator's decision may correspond to indicate an obstacle is an actual obstacle (“true positive”) indicating that the one or more detected obstacles are indeed real obstacles. In some embodiments, the operator's decision may correspond to indicate an obstacle is not an obstacle (“false positive”) indicating that the one or more detected obstacles are not real obstacles. In case of a “true positive”, future or current navigation paths can be modified by the controller 176 and/or the controller 150 or the ongoing operation/behavior of the autonomous vehicle 110A. In some embodiments, the operator may place or mark a threat/danger indication on the geolocation map on the display 188 based on “true positive” detection. In some embodiments, the operator may add the one or more obstacles on the geolocation map based on “true positive” detection. In case of a “false positive”, the operator can ignore the obstacle notification or the warning associated with the one or more obstacles. The base station controller 176 may share information regarding obstacles that are true positives and those that are false positives with a plurality of autonomous vehicles.

In some embodiments, the process 500 further includes transmitting by the transceiver 178 to the base station 174 the information associated with the one or more obstacles 425 detected in and around the navigation path 420. In some embodiments, the process 500 further includes modifying the navigation path or a behavior of the autonomous vehicle 110A based on an instruction received from the base station 174 via the transceiver 178. In some embodiments, the instruction corresponds to one of ignoring or avoiding (an interaction with) the one or more obstacles 425 around the navigation path of the autonomous vehicle 110A, for example. In some embodiments, such instructions may correspond to commands or input from the remote operator (of the base station 174) in response to the obstacle notification from the autonomous vehicle 110A.

In some embodiments, the operator input from the remote operator may override a false detection (“false positive”) of obstacles by the autonomous vehicle 110. In some embodiments, the operator input from the remote operator may override a determination of a “true positive” or a “false positive” by the artificial intelligence engine 190. In some embodiments, the operator interface 186 provides the remote operator with options to update the geolocation map based on a determination of “true positive” or “false positive” in a similar manner as in the case of the operator of the autonomous vehicle 110A. In some embodiments, the operator input from the remote operator may override determination of a “true positive” or a “false positive” by the operator of the autonomous vehicle 110A.

In some embodiments, the process 500 further includes receiving via the transceiver 178 from a base station 174 or from another autonomous vehicle (e.g. 110C), the geolocation map indicating location(s) of a first set of obstacles shared between a group of autonomous vehicles (e.g. 110B, 110C, 110D, 110E, 110F). In some embodiments, the first set of obstacles include the one or more obstacles 425 detected in and around the navigation path 420. In some embodiments, the method further includes modifying the navigation path or a behavior of the autonomous vehicle 110A based on the first set of obstacles indicated in the geological map. In some embodiments, the location(s) of the first set of obstacles correspond to relative location(s) of the first set of obstacles with respect to the autonomous vehicle using the geolocation map.

In some embodiments, the operators of the autonomous vehicle (in the group of autonomous vehicles) and/or the operator of the base station may add or remove obstacles based on their judgement about the one or more obstacles. In some embodiments, one of the operators (of the group of autonomous vehicles) may be pre-designated as an administrator whose decision or input may override the decision and inputs of the other operators. In some embodiments, the operator of the base station may correspond to the pre-designated administrator. In some embodiments, the role of an administrator may be assigned to one or more operators based on a polling or voting mechanism. In some other embodiments, the role of an administrator may be re-assigned periodically to multiple operators as per a random sequence or a deterministic algorithm.

In some embodiments, the operator (administrator or otherwise) may add the one or more obstacles to future navigation path plans for the autonomous vehicle 110A and/or the group of autonomous vehicles based on the modified/updated geolocation map. In some embodiments, the operator of the autonomous vehicle 110A or the operator of the base station 174 may remove the one or more obstacles from the geolocation map.

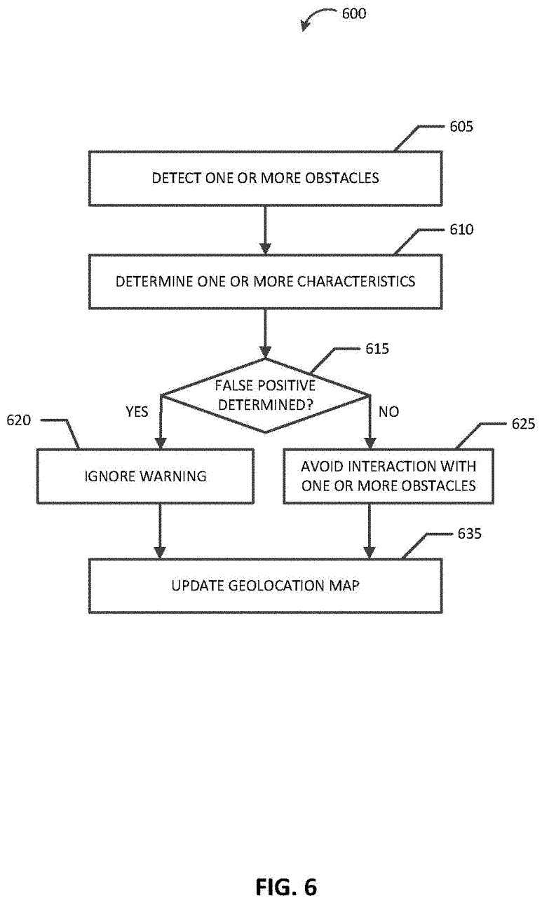

FIG. 6 illustrates a flowchart of a process 600 for determining false positives in obstacle detection according to some embodiments. Process 600 may include additional blocks. The blocks shown in process 600 may occur in any order. One or more blocks shown in process 600 may be replaced with another block or removed.

At step 605, one or more obstacles may be detected by an autonomous vehicle. For example, the sensor data is generated by the sensor array 179 in the autonomous vehicle 110A. In some embodiments, the sensor data is indicative of a presence of one or more obstacles 425 in and around the navigation path 420. In some embodiments, the artificial intelligence engine 190 detects the one or more obstacles 425 based on one or more mathematical models. The mathematical models can correspond to object modelling algorithms that help determine the type of obstacle indicated by the sensor data. The artificial intelligence engine 190 may receive sensor data from the sensor array and accurately detect the one or more obstacles.

At step 610, one or more characteristics associated with the one or more obstacles may be determined. For example, the mathematical models in the artificial intelligence engine 190 determine the one or more characteristics associated with the one or more detected obstacles.

At step 615, it is determined whether the one or more detected obstacles along the navigation path correspond to a “true positive” or a “false positive”. In some embodiment, the determination of a false or a true positive is based at least in part on the one or more characteristics associated with the one or more obstacles. If it is determined that the one or more obstacles correspond to a “false positive”, then the process proceeds to step 620. On the other hand, if it is determined that the one or more obstacles do not correspond to a “false positive”, then the process proceeds to step 625. In some embodiments, the determination of a “true positive” or a “false positive” may be based on operator input from an operator. For example, the operator may receive one or more recommendations or obstacle notifications from the artificial intelligence engine 190. The operator oversight over and beyond the detection by the artificial intelligence engine 190 provides an additional layer of verification for the detection of the one or more obstacles. Such an additional layer of verification leads to high accuracies in obstacle detection and avoidance.

At step 620, a warning or an obstacle notification associated with the one or more obstacles detected in and around the navigation path is ignored. In some embodiments, the determination of a false positive by the artificial intelligence engine 190 automatically rejects the obstacle notification. In some embodiments, the autonomous vehicle 110A continues along the navigation path 420 because of rejection of the obstacle notification.

At step 625, interaction with the one or more obstacles may be avoided. In some embodiments, the autonomous vehicle 110A may avoid interaction or collision with the one or more obstacles by using the steering control system 144 and the speed control system 146. In some embodiments, the process 600 includes modifying the navigation path or a behavior of the autonomous vehicle to avoid an interaction with the one or more obstacles.

At step 630, geolocation map may be updated based on the outcome of the determination of false positive. For example, if it was determined that the one or more obstacles did not correspond to a false positive, the geolocation map may be updated to include information associated with the one or more obstacle. In another example, if it was determined that the one or more obstacles did correspond to a false positive, the geolocation map may be updated to automatically remove information associated with the one or more obstacle if present. In some embodiments, the information includes location information, type of obstacle, one or more characteristics associated with the obstacle, etc. In some embodiments, the updated geolocation may be periodically shared with other autonomous vehicles in the group of autonomous vehicles or a base station.

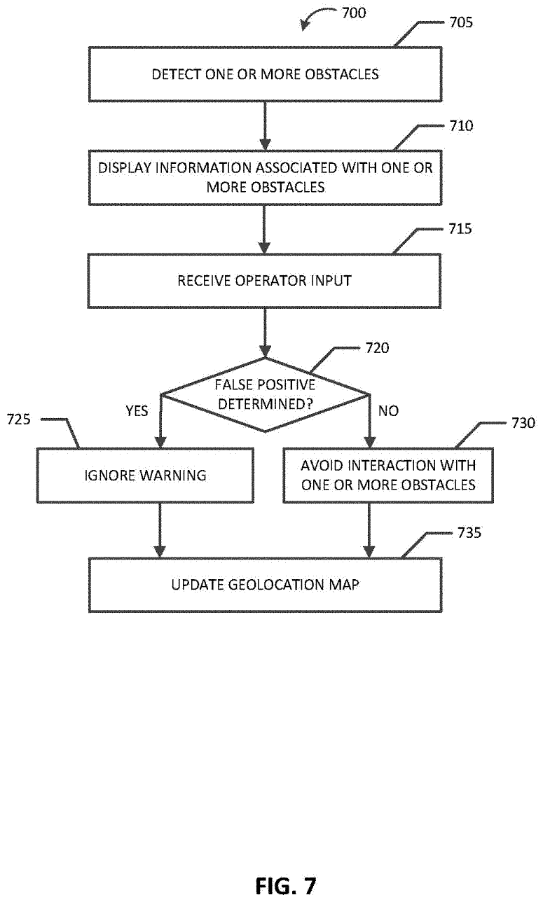

FIG. 7 illustrates a flowchart of a process 700 for determining false positives in obstacle detection according to some embodiments. Process 700 may include additional blocks. The blocks shown in process 700 may occur in any order. One or more blocks shown in process 700 may be replaced with another block or removed.

At step 705, one or more obstacles may be detected by an autonomous vehicle. For example, the one or more obstacles 425 may be detected by the sensor array 179 in the autonomous vehicle 110A.

At step 710, information associated with the one or more obstacles may be displayed on an operator interface such as, for example, operator interface 186. For example, the information associated with the one or more obstacles may be displayed as a list of obstacles on the operator interface 186. For example, the information associated with the one or more obstacles 420 may be displayed on a display 172 in the operator interface 152. In another example, the information associated with the one or more obstacles may be displayed as a list of obstacles on the operator interface 186. For example, the information associated with the one or more obstacles 420 may be displayed on a display 188 in the operator interface 186. The information about the obstacle, for example, may include raw sensor data such as, for example, LIDAR data, radar data, a visual image from a camera, a graphical representation of data (e.g., sensor data), etc. The information about the obstacle, for example, may include occupancy grids or cost grids. The information about the obstacle, for example, may include renderings created from raw sensor data such as, for example, three-dimensional drawings of an obstacle. The information about the obstacle, for example, may include data or information from more than one autonomous vehicle such as, for example, the size of the obstacle, location of the obstacle, etc.

In some embodiments, the information associated with the one or more obstacles may include an image or a live camera feed of the one or more obstacles. In some embodiments, the information associated with the one or more obstacles may be communicated to the operator using audio devices. As described earlier, the operator may correspond to the operator of the autonomous vehicle 110A or the operator of the base station 174. In some embodiments, the operator may correspond to a pre-designated administrator whose input and decision may override the input/decision of other operators.

At step 715, an operator input may be received in response to the displaying of information associated with the one or more obstacles 420. In some embodiments, the operator input may be a touch input or a voice input or a gesture input. In some embodiments, the operator input and the information associated with the one or more obstacles are transmitted to a base station or to other autonomous vehicles in the group of autonomous vehicles. In some embodiments, the process 700 includes modifying the navigation path or a behavior of the autonomous vehicle 110A based on the received operator input.

At step 720, it is determined whether the one or more obstacles correspond to a “false positive” or an “unreal determination/detection”. In some embodiments, the operator may provide an operator input based on his/her discretion or judgement. For example, if the operator input indicates that the one or more obstacles correspond to a “false positive”, then the process proceeds to step 725. On the other hand, if the operator input indicates that the one or more obstacles does not correspond to a “false positive”, then the process proceeds to step 730.

At step 725, warning associated with the one or more obstacles detected in and around the navigation path is ignored. In some embodiments, the operator input indicating a false positive detection automatically rejects an obstacle notification or warning that indicates a potential interaction. In some embodiments, upon detection of a “false positive”, the autonomous vehicle 110A continues along the navigation path 420.

At step 730, interaction with the one or more obstacles may be avoided. In some embodiments, the autonomous vehicle 110A may avoid interaction or collision with the one or more obstacles by using the steering control system 144 and the speed control system 146. In some embodiments, the process 700 includes modifying the navigation path or a behavior of the autonomous vehicle to avoid an interaction with the one or more obstacles.

At step 735, geolocation map may be updated based on the outcome of the determination of false positive. For example, if it was determined that the one or more obstacles did not correspond to a false positive, the geolocation map may be updated by the operator to include information associated with the one or more obstacle. For example, if it was determined that the one or more obstacles did correspond to a false positive, the geolocation map may be updated by the operator to exclude or remove information associated with the one or more obstacle (if already present). In some embodiments, the information includes image, type of obstacle, one or more characteristics associated with the obstacle, etc.

In some embodiments, the operator of the autonomous vehicle and/or the base station may add or remove obstacles based on their judgement about the one or more obstacles. In some embodiments, the operator (administrator or otherwise) may add the one or more obstacles to future navigation path plans for the autonomous vehicle 110A based on the modified geolocation map. In some embodiments, the operator of the autonomous vehicle 110A or the operator of the base station 174 may remove the one or more obstacles from the geolocation map. As described earlier, the geolocation map may be stored locally or remotely. In some embodiments, the updated geolocation map may be shared amongst the group of autonomous vehicles. In some embodiments, with time and continuous updates, the geolocation map may reflect/indicate the most recent set of obstacles (e.g. first set of obstacles) in the work area or in and around the group of autonomous vehicles.

FIG. 8 is a block diagram of a computational system 800 that can be used to with or to perform some embodiments described in this document.

The computational system 800, shown in FIG. 8 can be used to perform any of the embodiments of the invention. For example, computational system 800 can be used to execute processes (e.g. 500, 600, 700) or implement the publish-subscribe architecture described in this document. As another example, computational system 800 can be used perform any calculation, identification and/or determination described here. Computational system 800 includes hardware elements that can be electrically coupled via a bus 805 (or may otherwise be in communication, as appropriate). The hardware elements can include one or more processors 810, including without limitation one or more general-purpose processors and/or one or more special-purpose processors (such as digital signal processing chips, graphics acceleration chips, and/or the like); one or more input devices 815, which can include without limitation a mouse, a keyboard and/or the like; and one or more output devices 820, which can include without limitation a display device, a printer and/or the like.

The computational system 800 may further include (and/or be in communication with) one or more storage devices 825, which can include, without limitation, local and/or network accessible storage and/or can include, without limitation, a disk drive, a drive array, an optical storage device, a solid-state storage device, such as a random access memory (“RAM”) and/or a read-only memory (“ROM”), which can be programmable, flash-updateable and/or the like. The computational system 800 might also include a communications subsystem 830, which can include without limitation a modem, a network card (wireless or wired), an infrared communication device, a wireless communication device and/or chipset (such as a Bluetooth device, an 802.6 device, a Wi-Fi device, a WiMax device, cellular communication facilities, etc.), and/or the like. The communications subsystem 830 may permit data to be exchanged with a network (such as the network described below, to name one example), and/or any other devices described in this document. In many embodiments, the computational system 800 will further include a working memory 835, which can include a RAM or ROM device, as described above.

The computational system 800 also can include software elements, shown as being currently located within the working memory 835, including an operating system 840 and/or other code, such as one or more application programs 845, which may include computer programs of the invention, and/or may be designed to implement methods of the invention and/or configure systems of the invention, as described herein. For example, one or more procedures described with respect to the method(s) discussed above might be implemented as code and/or instructions executable by a computer (and/or a processor within a computer). A set of these instructions and/or codes might be stored on a computer-readable storage medium, such as the storage device(s) 825 described above.

In some cases, the storage medium might be incorporated within the computational system 800 or in communication with the computational system 800. In other embodiments, the storage medium might be separate from a computational system 800 (e.g., a removable medium, such as a compact disc, etc.), and/or provided in an installation package, such that the storage medium can be used to program a general-purpose computer with the instructions/code stored thereon. These instructions might take the form of executable code, which is executable by the computational system 800 and/or might take the form of source and/or installable code, which, upon compilation and/or installation on the computational system 800 (e.g., using any of a variety of generally available compilers, installation programs, compression/decompression utilities, etc.) then takes the form of executable code.

Unless otherwise specified, the term “substantially” means within 5% or 10% of the value referred to or within manufacturing tolerances. Unless otherwise specified, the term “about” means within 5% or 10% of the value referred to or within manufacturing tolerances.

The conjunction “or” is inclusive.

The terms “first”, “second”, “third”, etc. are used to distinguish respective elements and are not used to denote a particular order of those elements unless otherwise specified or order is explicitly described or required.

Numerous specific details are set forth to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared, or otherwise manipulated. It has proven convenient at times, principally for reasons of common usage, to refer to such signals as bits, data, values, elements, symbols, characters, terms, numbers, numerals, or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained in software to be used in programming or configuring a computing device.

Embodiments of the methods disclosed may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

1. An autonomous vehicle comprising:
a sensor array that produces sensor data;
a transceiver that communicates with and receives data from at least a base station; and
a controller communicatively coupled with the sensor array and the transceiver, the controller has code that
identifies one or more perceived obstacles based on the sensor data;
communicates the perceived obstacles to a base station via the transceiver;
receives navigation plan data via the transceiver that includes data specifying whether the one or more perceived obstacle is or is not an actual obstacle; and
navigates the autonomous vehicle along a navigation path specified in the navigation plan data in such a manner as to avoid an interaction with one or more perceived obstacles, in and around the navigation path, detected based at least in part on the sensor data.

2. (canceled)

3. (canceled)

4. (canceled)

5. (canceled)

6. The autonomous vehicle according to claim 1, wherein the controller has code that detects the one or more perceived obstacles based on terrain sensing and ground/no-ground segmentation associated with the navigation path.

7. (canceled)

8. The autonomous vehicle according to claim 1, wherein the controller has code that modifies the navigation path or a behavior of the autonomous vehicle based on an instruction received from a base station via the transceiver

9. (canceled)

10. The autonomous vehicle according to claim 1, wherein the controller has code that receives via the transceiver from a base station, a geolocation map indicating location(s) of a first set of actual obstacles shared between a group of autonomous vehicles.

11. The autonomous vehicle according to claim 10, wherein the first set of actual obstacles include the one or more perceived obstacles detected in and around the navigation path.

12. (canceled)

13. The autonomous vehicle according to claim 10, wherein the location(s) of the first set of obstacles correspond to relative location(s) of the first set of obstacles with respect to the autonomous vehicle.

14. The autonomous vehicle according to claim 1, further comprising an artificial intelligence engine communicatively coupled with the controller, wherein the controller has code that instructs the artificial intelligence engine to determine whether the one or more perceived obstacles detected in and around the navigation path correspond to one or more actual obstacles.

15. The autonomous vehicle according to claim 14, wherein the controller has code that modifies the navigation path or a behavior of the autonomous vehicle based on the determination by the artificial intelligence engine.

16. The autonomous vehicle according to claim 14, wherein the controller includes code that ignores warnings indicating a potential interaction of the autonomous vehicle with the one or more actual obstacles based on the determination by the artificial intelligence engine.

17. The autonomous vehicle according to claim 14, wherein the artificial intelligence engine comprises one or more mathematical models to determine one or more characteristics associated with the one or more perceived obstacles, and wherein the determination of whether the one or more perceived obstacles correspond to one or more actual obstacles is based at least in part on the determined one or more characteristics.

18. A method comprising:
generating sensor data by a sensor array in an autonomous vehicle;
communicating the perceived obstacles to a remote computer system via the transceiver;
receiving navigation plan data from the remote computer via the transceiver that includes data specifying whether the one or more perceived obstacle is or is not an actual obstacle; and
navigating the autonomous vehicle along a navigation path specified in the navigation plan data in such a manner as to avoid an interaction with one or more perceived obstacles, in and around the navigation path, detected based at least in part on the sensor data.

19. (canceled)

20. The method according to claim 18, further comprising displaying information associated with the one or more perceived obstacles on a display.

21. The method according to claim 20, further comprising receiving an operator input in response to the displaying of information associated with the one or more perceived obstacles.

22. (canceled)

23. The method according to claim 18, further comprising detecting the one or more perceived obstacles based on terrain sensing and ground/no-ground segmentation associated with the navigation path.

24. The method according to claim 18, further comprising modifying the navigation path or a behavior of the autonomous vehicle based on the one or more actual obstacles detected in and around the navigation path.

25. The method according to claim 18, further comprising transmitting by the transceiver to a base station the information associated with the one or more perceived obstacles detected in and around the navigation path.

26. (canceled)

27. (canceled)

28. The method according to claim 18, further comprising receiving via the transceiver from a base station, a geolocation map indicating location(s) of a first set of obstacles shared between a group of autonomous vehicles.

29. The method according to claim 28, wherein the first set of obstacles include the one or more perceived obstacles detected in and around the navigation path.

30. The method according to claim 28, further comprising modifying the navigation path or a behavior of the autonomous vehicle based on the first set of obstacles indicated in the geolocation map.

31. (canceled)

32. The method according to claim 18, further comprising instructing an artificial intelligence engine to determine whether the one or more perceived obstacles detected along the navigation path correspond to a true positive or a false positive.

33. (canceled)

34. (canceled)

35. (canceled)
